(19) United States
(12) Patent Application Publication
(10) Pub. No.: US 2016/0051448 A1
(43) Pub. Date: Feb. 25, 2016

(54) Pill Cutting Device

(71) Applicant: Lou Ferraro, Durham, CT (US)

(72) Inventor: Lou Ferraro, Durham, CT (US)

(21) Appl. No.: 14/833,371

(22) Filed: Aug. 24, 2015

Related U.S. Application Data
(60) Provisional application No. 62/040,603, filed on Aug. 22, 2014.

(51) Int. Cl. A61J 7/00

(52) U.S. Cl. CPC A61J 7/0007

(57) ABSTRACT

A pill cutting device for use in dividing a pill into a plurality of pieces. The pill cutting device includes a lower housing pivotally secured to an upper housing. The lower housing includes a pill holder having a recessed area in which a pill can be positioned. The pill holder further includes a pair of movable support arms, wherein the support arms can be used to hold pills of different shapes and sizes in a desired position for cutting. The upper housing includes a cutting blade for use in cutting the pill into several pieces, wherein the cutting blade is aligned with the recessed area of the pill holder. Preferably, the cutting blade comprises an X-shape so as to divide the pill into four pieces. The lower housing further includes a chamber in which the cut pill can be stored after being split into multiple pieces.

### CROSS REFERENCE TO RELATED APPLICATION

This application claims the benefit of U.S. Provisional Application No. 62/040,603 filed on Aug. 22, 2014. The above identified patent application is herein incorporated by reference in its entirety to provide continuity of disclosure.

### BACKGROUND OF THE INVENTION

### Field of the Invention

The present invention relates to pill cutting devices. More specifically, the present invention provides a pill cutting device comprising a lower housing having a pill holder and an upper housing having a blade adapted to divide a pill into a plurality of pieces. Preferably, the blade comprises an X-shape so as to divide the pill into four pieces when the upper housing is actuated downwardly towards the lower housing.

Many people have difficulty swallowing pills. Some pills are relatively large, making it difficult to swallow the entire pill in one-piece. Further, pills often have a harsh taste making it unpleasant for the user to take the entire pill at a single time. As a result, many people resort to cutting a pill into one or more pieces in order to make the pill easier to ingest. However, cutting a pill with a knife can be very difficult and dangerous. The user must hold the pill in place while simultaneously cutting the pill. The user may accidentally cut himself or herself if the pill slips out of position while the user is attempting to cut the pill. Even if the user can split the pill, the pill may not be split evenly resulting in one piece being larger than the other. Further, the force required to split the pill into multiple pieces may cause one or more sections of the pill to scatter or fall onto the floor.

Some devices are known that are used to cut a pill into two halves. However, such devices are generally not adapted for use with various types of pills. As a result, some pills may not be securely held within the pill cutting device, and the pill may not be cut evenly or successfully. Further, conventional pill cutters only allow the user to cut a pill into two pieces. Two pieces may still be too large for the user to consume, and the user may wish to further divide the pill into smaller pieces. Thus, a device for cutting various types of pills into a plurality of pieces is desired.

Devices have been disclosed in the prior art that relate to pill splitting devices. These include devices that have been patented and published in patent application publications. These devices generally relate to pill cutting devices for cutting a pill into two or more pieces, such as U.S. Pat. No. 6,968,987, U.S. Pat. No. 7,828,181, U.S. Pat. No. 7,458,300, U.S. Pat. No. 4,824,000, and U.S. Published Patent Application Number 2009/0183373.

These prior art devices have several known drawbacks. The devices in the prior art fail to disclose a pill cutting device having a lower housing with a pill holder and an upper housing with a cutting blade, wherein the blade is adapted to cut the pill into a plurality of pieces. Further, the devices in the prior art do not disclose a pill cutting device having a pill holder with movable support arms that can be used to hold pills of various sizes and shapes in a desired position for cutting.

In light of the devices disclosed in the prior art, it is submitted that the present invention substantially diverges in design elements from the prior art and consequently it is clear that there is a need in the art for an improvement to existing pill cutting devices. In this regard the instant invention substantially fulfills these needs.

### SUMMARY OF THE INVENTION

In view of the foregoing disadvantages inherent in the known types of pill cutting devices now present in the prior art, the present invention provides a new pill cutting device wherein the same can be utilized for providing convenience for the user when dividing a pill into a plurality of pieces.

It is therefore an object of the present invention to provide a new and improved pill cutting device comprising a lower housing having a pill holder thereon and an upper housing pivotally secured thereto wherein the upper housing includes a cutting blade adapted to divide the pill positioned on the pill holder into a plurality of pieces.

It is another object of the present invention to provide a pill cutting device comprising a lower housing with a chamber used to store the pill once it has been split.

Another object of the present invention is to provide a pill cutting device comprising a pill holder having a recessed area and a pair of movable support arms that can be adjusted so as to hold pills of various shapes and sizes.

Yet another object of the present invention is to provide a pill cutting device having an X-shaped cutting blade for use in cutting a pill into four pieces.

Another object of the present invention is to provide a pill cutting device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the pill cutting device in a closed configuration.

FIG. 2 shows a perspective view of the pill cutting device in an open configuration.

FIG. 3 an overhead view of the pill cutting device in an open configuration.

### DETAILED DESCRIPTION OF THE INVENTION

Reference is made herein to the attached drawings. Like reference numerals are used throughout the drawings to depict like or similar elements of the pill cutting device. For the purposes of presenting a brief and clear description of the present invention, the preferred embodiment will be discussed as used for splitting a pill into a plurality of pieces. The figures are intended for representative purposes only and should not be considered to be limiting in any respect.

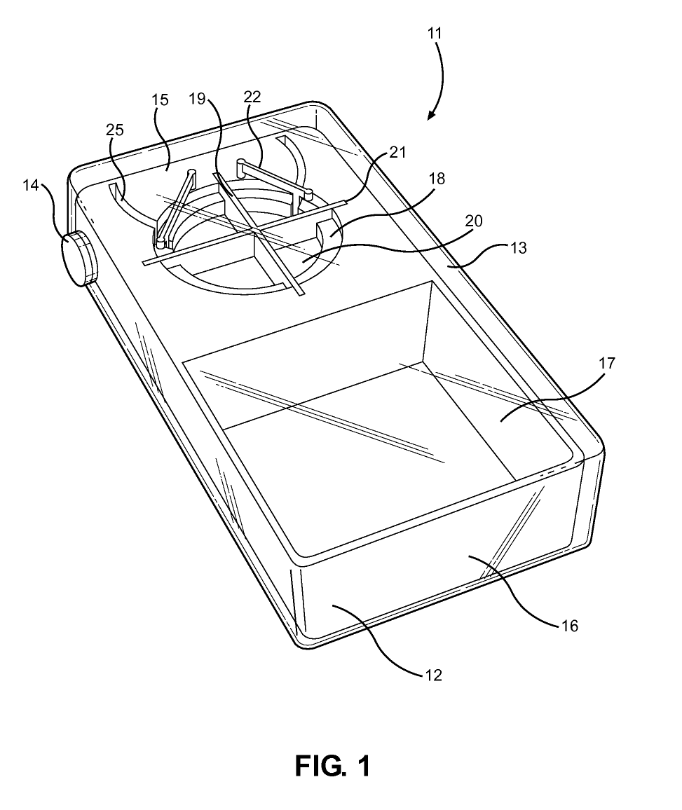

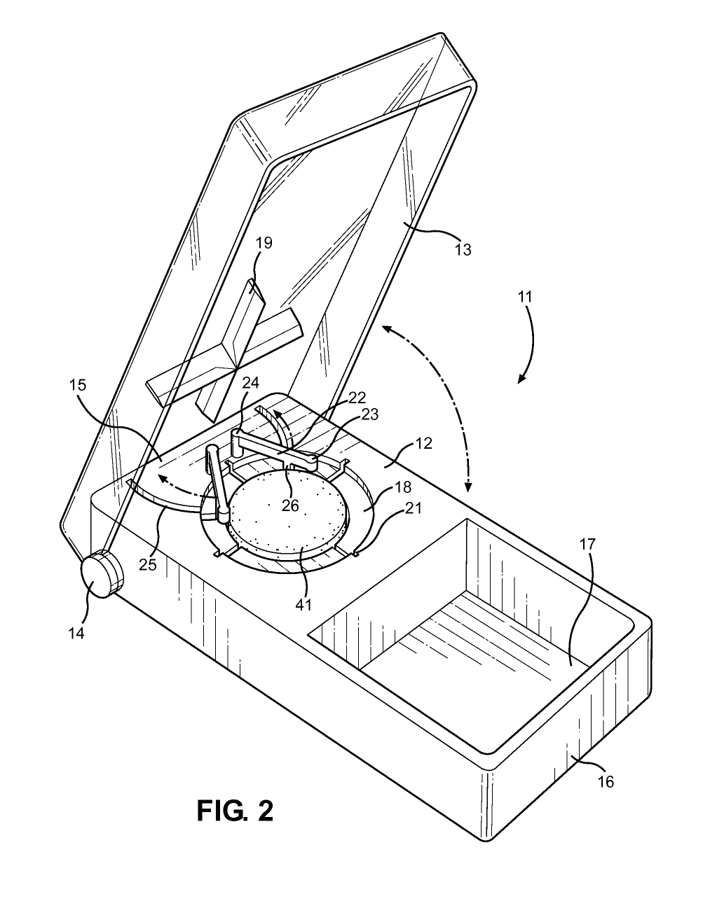

Referring now to FIGS. 1 and 2, there are shown perspective views of an embodiment of the pill cutting device in a closed configuration and an open configuration, respectively. The pill cutting device 11 comprises a lower housing 12 pivotally secured to an upper housing 13 via a hinge 14, and further includes a front portion 16 and a rear portion 15. The hinge 14 is preferably located on the rear portion 15 of the lower and upper housing 12, 13. The lower housing 12 includes a pill holder 20 at the rear portion 15 thereof, and a chamber 17 on the front portion 16 thereof for storing a pill or sections of a pill. The rear portion 15 of the upper housing 13 comprises a cutting blade 19 adapted to cut a pill positioned within the pill holder 20 of the lower housing 12.

In the illustrated embodiment, the lower housing 12 comprises a substantially rectangular configuration. The rear portion 15 of the lower housing 12 includes a pill holder 20 adapted to secure a pill in a desired position for cutting. The pill holder 20 comprises a recessed area 18 in which the pill can be positioned. The recessed area 18 helps to maintain the pill in position for cutting so that the pill does not move during the cutting process. The recessed area 18 is preferably circular in shape so as to be similarly shaped as many conventional pills. However, in alternate embodiments, the recessed area 18 may have other shapes, such as an elliptical shape.

The recessed area 18 includes one or more slots 21 that correspond to the location of the cutting blade 19 when the cutting blade 19 is lowered onto the lower housing 12. In this way, the cutting blade 19 can pass through the pill and can fit into the slots 21 disposed on the recessed area 18 in order to ensure that the pill is fully and completely divided. Thus, in the illustrated embodiment, the slots 21 have an X-shape so as to receive the X-shaped cutting blade 19 therein.

The pill holder 20 further includes a pair of support arms 22. The support arms 22 have a first end 23 and a second end 24. The second end 24 is pivotally affixed to the rear portion 15 of the lower housing 12, such that support arm 22 can rotate about the second end 24 in order to move the first end 23 into contact with the exterior or perimeter of a pill. Each support arm 22 further includes a post 26 that is slidably positioned within a channel 25 that extends from the recessed area 18. The post 26 moves within the channel 25 as the support arm 22 is rotated about the second end 24 thereof. The channels 25 are positioned on opposing sides of the recessed area 18 and help to guide the movement of the support arms 22. The support arms 22 can be adjusted so that they contact a pill held within the recessed area 18 and help to provide further support to the pill held therein.

In the illustrated embodiment, the front portion 16 of the lower housing 12 includes a chamber 17. The chamber 17 provides an interior volume in which the pill can be stored once it has been divided. The chamber 17 is shown as having a rectangular configuration, however in alternate embodiments the chamber 17 can have other shapes. The chamber 17 is sized so that a pill or sections of a pill can be held therein. For example, once a user splits a pill using the pill cutting device 11, the user can consume one piece of the pill, and can store the remaining pieces in the chamber 17 for later consumption.

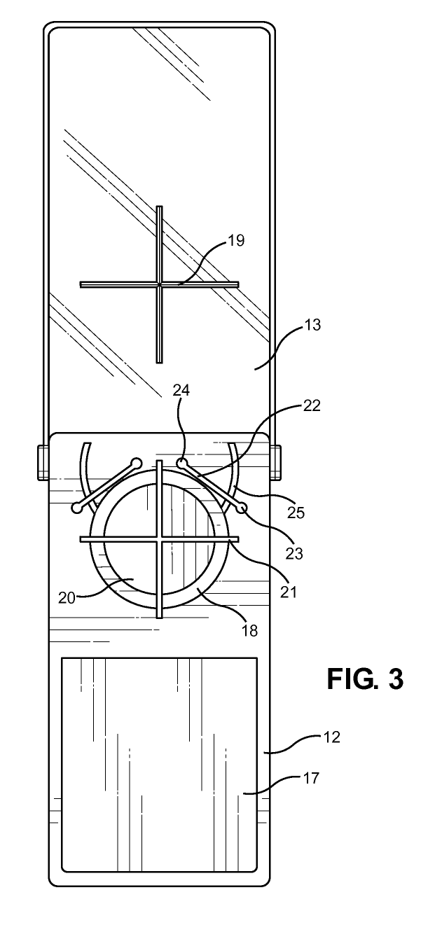

Referring now to FIG. 3, there is shown an overhead view of the pill cutting device in an open configuration. The rear portion 15 of the upper housing 13 comprises a cutting blade 19 thereon. The cutting blade 19 extends perpendicularly from the upper housing 13. The blade 19 is preferably shaped so as to divide a pill into a plurality of pieces. In a preferred embodiment, the cutting blade comprises an X-shape so as to divide a pill into four sections. Preferably, the cutting blade is adapted to divide a pill into four quarters, such that each section of the pill is of equal size and shape.

In operation, a user can insert a pill of any size or shape into the recessed area 18 of the lower housing 12. The user can then adjust the support arms 22 on opposing sides of the recessed area 18 by rotating each support arm 22 about the second end 24 thereof so that the first end 23 contacts the perimeter of the pill in order to maintain the pill in the desired position while the pill is being split. The user can then actuate the upper housing 13 downward and toward the lower housing 12 so that the cutting blade 19 engages and passes through the pill and into the slots 21 disposed on the recessed area 18. In this way, the blade 19 cuts the pill into several pieces, and the upper housing 13 and lower housing 12 prevent the pill from escaping the pill cutting device 11. Thus, the split pill is held within the pill cutting device 11 and can be stored within the chamber 17 on the lower housing 12 of the pill cutting device 11 until it is desired to be ingested.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pill cutting device, comprising:
an upper housing pivotally secured to a lower housing via a hinge;
said lower housing comprising a pill holder adapted to receive a pill for cutting, wherein said pill holder comprises a recessed area;
said upper housing comprising a cutting blade adapted to cut a pill into a plurality of pieces when said upper housing is rotated towards said lower housing.

2) The pill cutting device of claim 1, wherein said cutting blade comprises an X-shape.

3) The pill cutting device of claim 1, wherein said recessed area further includes one or more slots adapted to receive said cutting blade when said upper housing is actuated towards said lower housing.

4) The pilling cutting device of claim 3, wherein said one or more slots comprises a pair of slots configured to receive said cutting blade having an X-shape.

5) The pill cutting device of claim 1, wherein said pill holder further comprises a pair of support arms pivotally affixed to said lower housing, wherein said pair of support arms is adapted for use in holding said pill during cutting.

6) The pill cutting device of claim 5, wherein each of said pair of support arms is slidably positioned within a channel.

7) The pill cutting device of claim 6, wherein each said channel is disposed on opposing sides of said recessed area.

8) The pilling cutting device of claim 6, wherein each of said pair of support arms includes a post configured to be slidably positioned within said channel.

9) The pill cutting device of claim 1, wherein said lower housing further comprises a chamber in which a pill can be stored.
